(19) United States
(12) Patent Application Publication
(10) Pub. No.: US 2014/0223202 A1
(43) Pub. Date: Aug. 7, 2014

(54) ELECTRONIC DEVICE AND STARTING UP METHOD THEREOF

(71) Applicant: HON HAI PRECISION INDUSTRY CO., LTD., New Taipei (TW)

(72) Inventors: YI-RU LAI, New Taipei (TW); SHU-MING LIU, New Taipei (TW); CHIA-JUNG LIU, New Taipei (TW)

(73) Assignee: HON HAI PRECISION INDUSTRY CO., LTD., New Taipei (TW)

(21) Appl. No.: 14/160,565

(22) Filed: Jan. 22, 2014

(30) Foreign Application Priority Data
Feb. 4, 2013 (TW) 102104262

(51) Int. Cl. G06F 1/16

(52) U.S. Cl. CPC G06F 1/1633
USPC 713/300

(57) ABSTRACT

An electronic device includes a read only memory (ROM), a processing unit coupled to the ROM, a first sensing area coupled to the processing unit and a second sensing area coupled to the processing unit. The processing unit starts up when the first sensing area and the second sensing area are covered simultaneously by fingers of a hand of a user of the electronic device in a predetermined period of time.

### BACKGROUND

1. Technical Field

The present disclosure relates to an electronic device and a method for starting up the electronic device.

2. Description of Related Art

Portable electronic device such as a mobile phone has several states, for example, a working state and a sleep state. When the mobile phone is changed from the sleep state to the working state, a user needs to hold the mobile phone by one hand, and operate the mobile phone with the other hand. However, when the user is using one hand on other matter, it is difficult to operate the mobile phone with only one hand.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of an electronic device.

FIG. 2 is a front view of an embodiment of the electronic device of FIG. 1.

FIG. 3 is a top view of an embodiment of the electronic device of FIG. 2.

FIG. 4 is an isometric view of an embodiment of the electronic device in a working state.

FIG. 5 is a flow chart of an embodiment of a method for starting up the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blue-Ray discs, Flash memory, and hard disk drives.

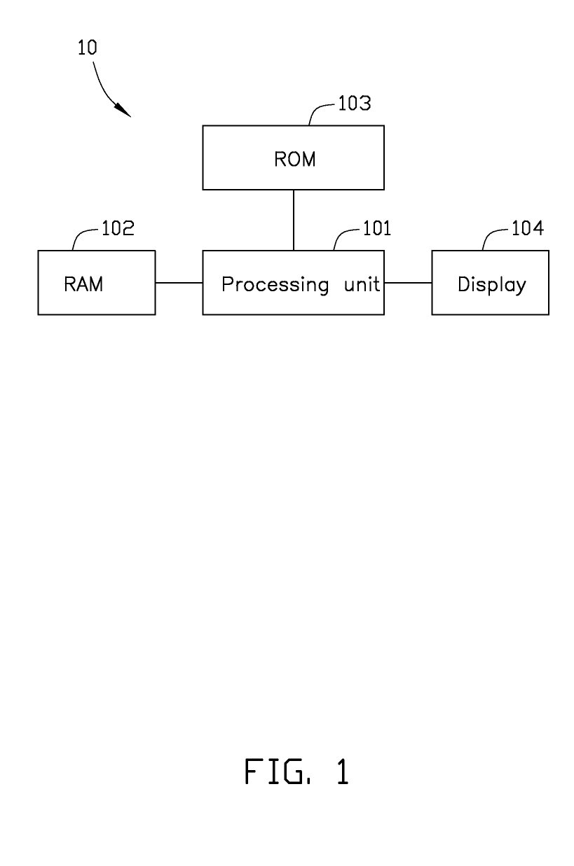

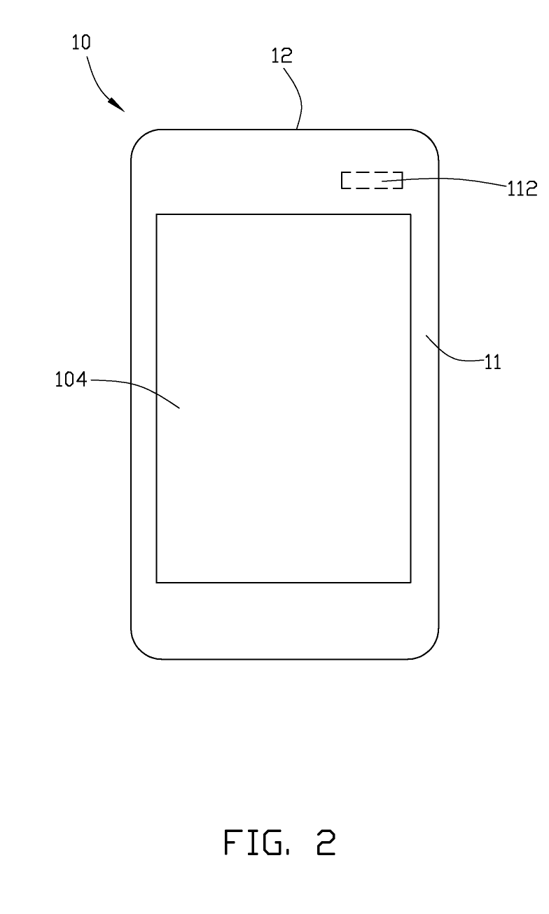

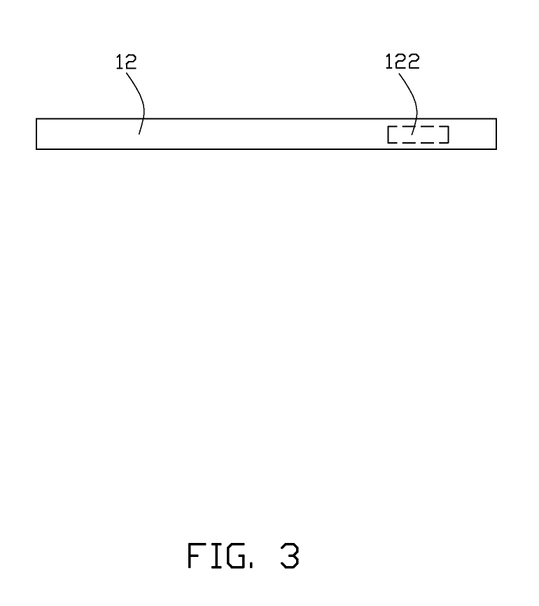

FIGS. 1 to 3 show an electronic device 10 in accordance with one embodiment. The electronic device 10 may be a smart phone, a panel computer, a personal digital assistant (PDA), a game machine, a digital video player, a wireless device, a portable television, for example. In the shown embodiment, the electronic device 10 is a smart phone.

The electronic device 10 includes a processing unit 101, a random access memory (RAM) 102, a read only memory (ROM) 103 and a display 104. The processing unit 101 is coupled to the RAM 102, the ROM 103 and the display 104. The processing unit 101 may include one or more processors that provide the processing capability to execute the operating system, programs, user and application interfaces.

The electronic device 10 has a substantially rectangular body. The electronic device 10 includes a front surface 11 and a side surface 12 substantially perpendicular to the front surface 11. The display 104 is located in a middle of the front surface 11 for displaying information. In another embodiment, the display 104 can also be a touch panel for inputting information. A first sensing area 112 is located in the front surface 11 above the display 104. A second sensing area 122 is located in the side surface 12. In one embodiment, the side surface 12 is located at a top side of the electronic device 10. In another embodiment, the side surface 12 can also be located at a left side or a right side of the electronic device 10. The first sensing area 112 can also be located in the top side, the left side or the right side of the electronic device 10.

The first sensing area 112 and the second sensing area 122 are coupled to the processing unit 101. The first sensing area 112 and the second sensing area 122 are configured to detect finger motions of a user (not shown) by detecting whether illumination of light to the first and second sensing areas 112, 122 is blocked by fingers of a hand of a user of the electronic device 10. The first sensing area 112 and the second sensing area 122 are substantially formed by carbon nano tube materials which are mounted on the electronic device 10. Therefore, a thickness of the first sensing area 112 and a thickness of the second sensing area 122 are reduced. When the first sensing area 112 and the second sensing area 122 are covered, illuminations of light detected by the first sensing area 112 and the second sensing area 122 are decreased.

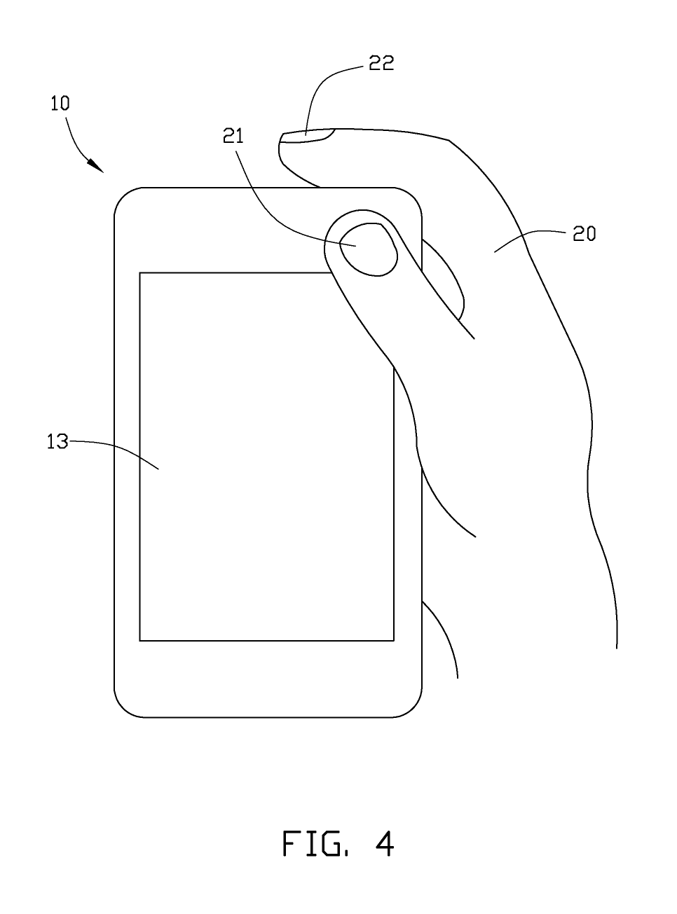

FIG. 4 shows that the electronic device 10 is held by a right hand 20 of the user when the electronic device 10 is used. A thumb 21 of the right hand 20 is positioned adjacent to the first sensing area 112. An index finger 22 of the right hand 20 is positioned adjacent to the second sensing area 122.

When the electronic device 10 is changed from a sleeping state to a working state, the thumb 21 is moved above the first sensing area 112 to cover the first sensing area 112, and the index finger 22 is moved above the second sensing area 122 to cover the second sensing area 122. When the thumb 21 covers the first sensing area 112 and the index finger 22 covers the second sensing area 122 simultaneously in a predetermined period of time, the first sensing area 112 and the second sensing area 122 outputs a start up signal to the processing unit 101. The processing unit 101 starts up. The electronic device 10 is unlocked and changed from the sleep state to the working state.

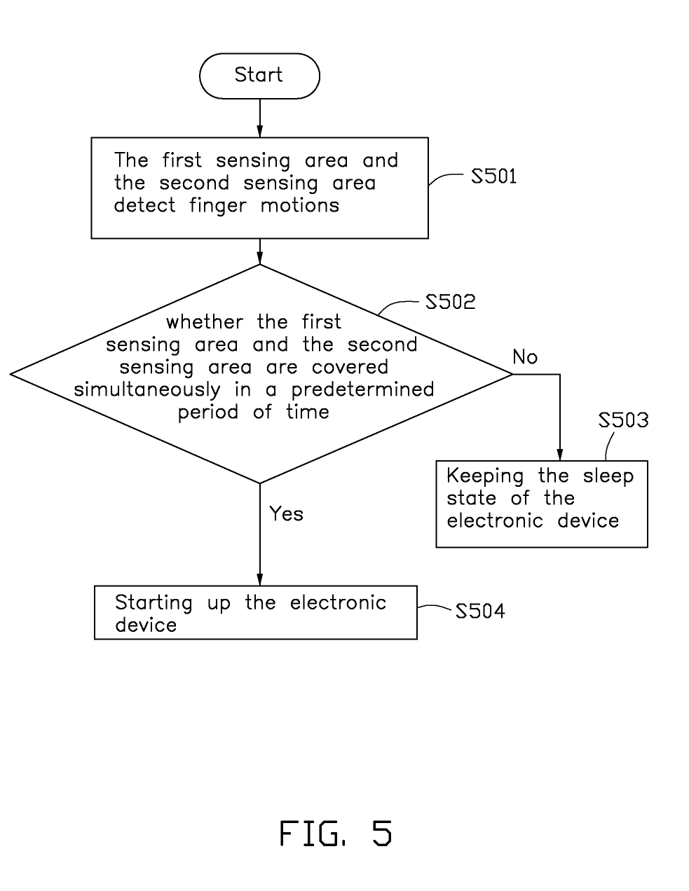

FIG. 5 shows a flow chart of a method for starting up the electronic device 10 in accordance with one embodiment. Depending on the embodiment, certain steps described below may be removed, while others may be added, and the sequence of the steps may be altered. In one embodiment, the method for starting up the electronic device 10 includes the following steps:

S501: the first sensing area 112 and the second sensing area 122 detect finger motions;

S502: the processing unit 101 determines whether the thumb 21 covers the first sensing area 112 and the index finger 22 covers the second sensing area 122 in the predetermined period of time simultaneously; if yes, the procedure goes to S504; if no, the procedure goes to S503;

S503: the processing unit 101 keeps the sleep state of the electronic device 10;

S504: the processing unit 101 starts up, and the electronic device 10 is unlocked and changed from the sleeping state to the working state.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An electronic device comprising:
a read only memory (ROM);
a processing unit coupled to the ROM;
a first sensing area coupled to the processing unit; and
a second sensing area coupled to the processing unit; wherein the processing unit is configured to start up when the first sensing area and the second sensing area are covered simultaneously in a predetermined period of time.

2. The electronic device of claim 1, further comprising a display coupled to the processing unit, wherein the display is located in a front surface of the electronic device, the first sensing area is located in the front surface above the display, and the second sensing area is located in a side surface of the electronic device.

3. The electronic device of claim 1, wherein the first sensing area and the second sensing area are substantially formed by carbon nano tube materials, and the first sensing area and the second sensing area are configured to detect finger motions by detecting whether illumination of light to the first and second sensing areas is blocked by figures of a hand of a user of the electronic device.

4. The electronic device of claim 2, wherein the side surface is located at a top side of the electronic device.

5. The electronic device of claim 2, wherein the side surface is located at a left side or a right side of the electronic device.

6. The electronic device of claim 2, wherein the side surface is substantially perpendicular to the front surface.

7. The electronic device of claim 1, wherein a thumb is positioned adjacent to the first sensing area, an index finger is positioned adjacent to the second sensing area, and the processing unit is configured to start up when the thumb covers the first sensing area and the index finger covers the second sensing area simultaneously in the predetermined period of time.

8. A method for starting up an electronic device, the method comprising:
a first sensing area and a second sensing area detecting finger motions;
a processing unit determining whether illuminations of light detected by the first sensing area and the second sensing area decreases simultaneously in a predetermined period of time;
the processing unit starting up when illuminations of light detected by the first sensing area and the second sensing area decreases simultaneously in the predetermined period of time; and
the processing unit keeping a sleep state of the electronic device when illuminations of light detected by the first sensing area and the second sensing area does not decrease simultaneously in the predetermined period of time.

9. The method of claim 8, wherein a thumb is positioned adjacent to the first sensing area, an index finger is positioned adjacent to the second sensing area, and the processing unit is configured to start up when the thumb covers the first sensing area and the index finger covers the second sensing area simultaneously for the predetermined period of time.

10. The method of claim 8, wherein the electronic device is changed from the sleep state to a working state when the processing unit starts up.

11. The method of claim 8, wherein the first sensing area and the second sensing area are substantially formed by carbon nano tube materials, and the first sensing area and the second sensing area are configured to detect finger motions by detecting whether illumination of light to the first and second sensing areas is blocked by fingers of a hand of a user of the electronic device.

12. The method of claim 8, wherein the first sensing area is located in a front surface of the electronic device, and the second sensing area is located in a side surface of the electronic device.

13. The method of claim 12, wherein a display is located in the front surface, the first sensing area is above the display; and the side surface is located at a top side of the electronic device.

14. The method of claim 12, wherein the side surface is located at a left side or a right side of the electronic device.

15. The method of claim 12, wherein the side surface is substantially perpendicular to the front surface.
